(19) United States
(12) Patent Application Publication
(10) Pub. No.: US 2010/0145516 A1
(43) Pub. Date: Jun. 10, 2010

(54) HIGH VOLTAGE MONITORING SYSTEM AND METHOD FOR SPRAY COATING SYSTEMS

(75) Inventors: Roger T. Cedoz, Curtice, OH (US); Thomas F. Murray, Beverly Hills, MI (US)

Correspondence Address: FLETCHER YODER (ILLINOIS TOOL WORKS INC.), P.O. BOX 692289, HOUSTON, TX, 77269-2289, US

(73) Assignee: Illinois Tool Works Inc., Glenview, IL (US)

(21) Appl. No.: 12/552,259

(22) Filed: Sep. 1, 2009

Related U.S. Application Data
(60) Provisional application No. 61/120,725, filed on Dec. 8, 2008.

(51) Int. Cl. B25J 13/08; B05B 5/053; G05D 7/06

(52) U.S. Cl. 700/258; 239/690; 700/283; 901/9; 901/43; 901/10

(57) ABSTRACT

In accordance with one embodiment, a system may include a high voltage coating applicator, a voltage sensor, and a coating system controller configured to automate a voltage measurement of the high voltage coating applicator by the voltage sensor. In another embodiment, a system may include a non-contact sensor and a controller coupled to the non-contact sensor, wherein the controller is configured to obtain a measurement indicative of voltage at a distance between an electrostatic spray device and the non-contact sensor. In the embodiment, the controller is also configured to adjust voltage, fluid flow, distance, or a combination thereof, of the electrostatic spray device in response to the measurement.

### BACKGROUND

The invention relates generally to a system and method for monitoring the performance of electrostatic spray coating systems and, more specifically, measuring the voltage of the applicators of coating systems.

Electrostatic spray coating systems utilize applicators that operate at high voltages. For example, a coating applicator of a system may conduct up to 100 kilovolts (kV) through its body when properly applying a coating to a target device. If the voltage of an applicator is not at certain levels, the coating process may be stopped to prevent low quality coating application, thereby preventing costly reworking of target objects. The process of measuring the applicator voltage can require several people to manually shut down the spray booth to allow entry, subsequently re-power the applicator, and physically apply a test probe to the applicator inside the spray booth.

### BRIEF DESCRIPTION

In accordance with one embodiment, a system may include a high voltage coating applicator, a voltage sensor, and a coating system controller configured to automate a voltage measurement of the high voltage coating applicator by the voltage sensor. In another embodiment, a system may include a non-contact sensor and a controller coupled to the non-contact sensor, wherein the controller is configured to obtain a measurement indicative of voltage at a distance between an electrostatic spray device and the non-contact sensor. In the embodiment, the controller is also configured to adjust voltage, fluid flow, distance, or a combination thereof, of the electrostatic spray device in response to the measurement.

### DRAWINGS

These and other features, aspects, and advantages of the present invention will become better understood when the following detailed description is read with reference to the accompanying drawings in which like characters represent like parts throughout the drawings, wherein:

FIG. 1 is a diagram of an embodiment of a spray coating system, including an automated voltage monitoring system for electrostatic coating applicators;

FIG. 2 is a side view of an embodiment of the system, as shown in FIG. 1, with a plurality of coating applicators maneuverable to be tested by the automated voltage monitoring system;

FIG. 3 is a detailed side view of an embodiment of the system, as shown in FIG. 1, with fans to control air flow within the coating system enclosure;

FIG. 4 is a detailed side view of an embodiment of the automated voltage monitoring system and a rotary atomizer applicator in contact with a voltage sensing device, in the form of a contact probe, wherein the bell cup is touching the sensor;

FIG. 5 is a detailed side view of an embodiment of the automated voltage monitoring system and a robotic gun applicator proximate to a voltage sensing device, in the form of a non contact test plate;

FIG. 6 is a flow chart illustrating an embodiment of the automated voltage monitoring system for spray coating;

FIG. 7 is a detailed flow chart illustrating an automated process for measuring the voltage of a spray applicator of the coating system;

FIG. 8 is a detailed flow chart illustrating a process for analyzing the voltage of a spray applicator of the coating system;

FIG. 9 is a detailed flow chart illustrating a process for adjusting system parameters in response to voltage measurement of a spray applicator;

FIG. 10 is a chart of applicator input voltage versus the voltage measured by a contact voltage sensor;

FIG. 11 is a chart of applicator input voltage versus the voltage measured by a non-contact voltage sensor; and

FIG. 12 is a chart of the distance between the applicator and non-contact sensor versus the voltage measured by the non-contact voltage sensor.

### DETAILED DESCRIPTION

One or more specific embodiments of the present invention will be described below. In an effort to provide a concise description of these embodiments, all features of an actual implementation may not be described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

When introducing elements of various embodiments of the present invention, the articles “a,” “an,” “the,” and “said” are intended to mean that there are one or more of the elements. The terms “comprising,” “including,” and “having” are intended to be inclusive and mean that there may be additional elements other than the listed elements. Any examples of operating parameters and/or environmental conditions are not exclusive of other parameters/conditions of the disclosed embodiments.

In certain embodiments, the systems and methods described herein include automatically measuring a high-voltage of an applicator used in an electrostatic coating system. The voltage may be measured with a contact sensor, non-contact sensor, or both. Further, the automated voltage measurement may use only a single operator to initiate the voltage sequence, rather than of several operators performing a manual measurement. For instance, a periodic automated voltage measurement may be performed using the automated system to ensure that the coating system is performing properly. If the voltage measured is too low or too high, then the system may make adjustments to ensure that the coating is properly applied to the targets. By providing an efficient and simple system for monitoring the high voltage of an applicator, the system ensures that the electrostatic spray process results in a high quality coating to reduce defects and improve the manufacturing process. The automated voltage measurements may be performed without shutting down a spray booth and without user entry into the spray booth, thereby reducing down time while improving performance of the electrostatic spray coating system. In other words, the voltage measurements may be substantially or entirely automated with regard to the positioning, test sequence, analysis, and subsequent controls or adjustments based on the voltage measurements.

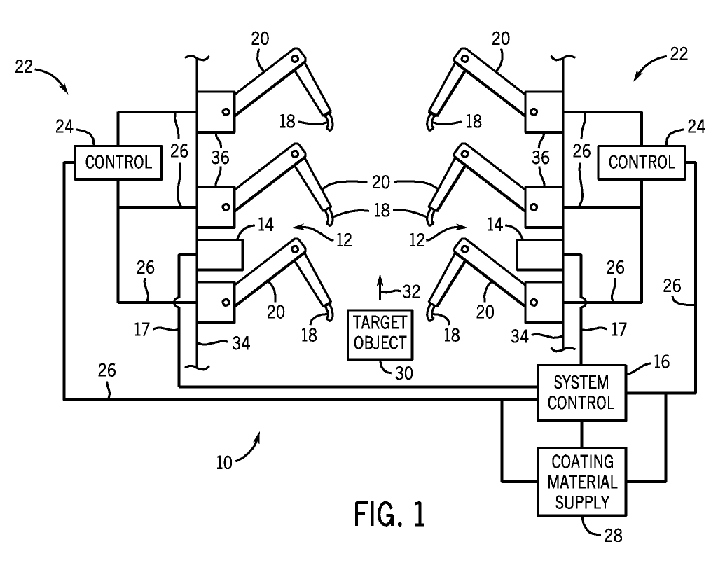

FIG. 1 is a block diagram of an embodiment of an electrostatic spray coating system 10. The illustrated electrostatic spray coating system 10 includes automated voltage measurement system 12. Automated voltage measurement system 12 may include several components such as voltage sensor device 14 and system control computer 16. In an embodiment, automated voltage measurement system 12 may include two voltage sensor devices 14, which may include any appropriate electronics and hardware in order to measure a high voltage. Voltage sensor devices 14 may be connected to system control computer 16 via leads or cables 17. Voltage sensor device 14 may be any suitable device, such as a volt meter, which measures a circuit's voltage. The unit under test (UUT) being measured in the automated voltage measurement system 12 is electrostatic applicator 18.

Electrostatic applicator 18 is an electrostatic mechanism for coating a target object that includes high voltage components. As illustrated, an electrostatic spray coating system 10 may include a plurality of robotic arms 20 that each have an electrostatic applicator 18 attached at the end of the arm. In an embodiment, the electrostatic applicators 18 may include a surface, component, and/or wire/electrode that conducts high voltage when applying a spray coating. As depicted, control circuitry 22 may be utilized to coordinate, position, and manipulate robotic arms 20 during a spray coating process and during an automated voltage measurement process. Robot control circuitry 22 may include control circuit boxes 24 and electrical connections 26, which may connect each circuit box 24 to each of the robotic control arms and to system control computer 16.

Further, coating material supply system 28 may be connected to system control computer 16 as well as robot control circuitry 22. For example, coating material supply system 28 may include a tank that supplies a paint or powder coating material via robot control circuitry 22, thereby enabling applicators 18 to apply the coating material to a target object 30 located within electrostatic spray coating system 10. The coating material supply system 28 may supply pressurized coating material to robotic arms 20 and applicators 18 in order to apply the coating material to the target object 30. As appreciated, electrostatic spray coating system 10 may be a booth or other enclosure to contain and block the airborne coating material from escaping into a work place and/or the outside environment. Moreover, the current diagram may be an illustration of only a portion of a larger electrostatic spray coating system 10.

As will be described in detail below, automated voltage measurement system 12 may utilize system control computer 16 to position applicators 18 via robotic arms 20 in order to allow voltage sensor devices 14 to measure an applicator 18 voltage level. In an embodiment, each of the robotic arms 20 may be located and spaced apart on a booth wall 34. Further, in the embodiment, voltage sensor device 14 may be located on booth wall 34, thereby enabling robotic arms 20 to position applicator 18 for a voltage measurement to be made by automated voltage measurement system 12. As depicted, robotic arm bases 36 may be mounted to a track located along booth wall 34, enabling the robotic arms 20 to move along booth wall 34 within a spray coating booth. Further, the automated voltage measurement system 12 may be stationary or movable along booth wall 34 to enable each of the applicators 18 to access the voltage sensor device 14 via the respective robotic arm 20. In certain embodiments, the robotic arms 20 may be mounted one over another in a vertical arrangement, one after another in a horizontal arrangement or a combination thereof.

In an embodiment, when voltage sensor device 14 and automated voltage measurement system 12 are performing a measurement, target object 30 may be removed from electrostatic spray coating system 10 and its enclosure. During the measurement procedure, each of the robotic arms 20 may position the applicators 18 to enable voltage sensor device 14 to measure the voltage of each of the applicators in a sequence. Further, the voltage sensor device 14 may communicate via connection 17 a voltage measurement for each of the applicators 18 to system control computer 16. As the voltages of applicators 18 are measured, the system control computer 16 may log the voltage measurements and compare them to predicted, historical, and/or other related data points for analysis. For instance, in one embodiment, applicator 18 may include a voltage ladder, wherein a voltage is sourced and amplified to applicator 18. The amplified voltage is connected to high voltage components within applicator 18 in order to produce the desired electrostatic spray coating arrangement. In the example, a known value resistor, such as a 10 giga-ohm resistor, may be electrically connected to the high voltage components of the applicator. In other embodiments, the known value resistor may be about a 1-15 giga-ohm resistor. A sensor may detect the current across this known value resistor, which may be used to calculate the voltage of the applicator 18. In some cases, however, the known value resistor may change over time due to wear and tear or as a result of damage to the resistor. In this case, an external voltage measurement may be used to calibrate the system and verify the voltage value of high voltage applicator 18.

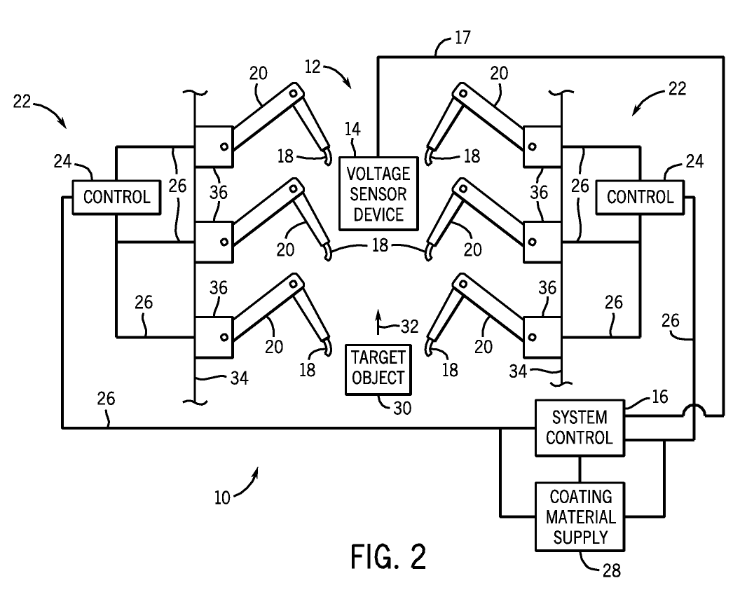

FIG. 2 is a top view of a block diagram of another embodiment of electrostatic spray coating system 10. The diagram includes system control computer 16, applicators 18, robotic arms 20, and voltage sensor device 14. As depicted, voltage sensor device 14 may be located in the center region of electrostatic spray coating system 10. Voltage sensor device 14 may be one or more voltage sensing units that may be accessed by all or a portion of the applicators 18 located within electrostatic spray coating system 10. Specifically, the applicators 18 are attached to robotic arms 20 having bases 36 mounted to booth walls 34 on each side of electrostatic spray coating system 10. Again, the robotic arms 20 may be mounted one over another in a vertical arrangement, one after another in a horizontal arrangement, or a combination thereof. In an embodiment, applicators 18 along each wall 34 may be monitored or measured by the same centrally located (e.g., horizontally and/or vertically centered) voltage sensor device 14. In an embodiment, voltage sensor device 14 may be located centrally in electrostatic spray coating system 10 and coupled to the ceiling of the system spray booth or other enclosure.

Further, voltage sensor device 14 may be located in such a manner to avoid overspray during application of the coating material to target object 30 as it moves along the center of electrostatic spray coating system 10 in direction 32. Moreover, target object 30 may move in direction 32 (e.g., horizontally) below voltage sensor device 14. By centrally locating voltage sensor device 14 and mounting it to the ceiling of the enclosure, voltage sensor device 14 avoids exposure to coating material overspray, while being centrally located for access to all of the system applicators 18. In particular, if the voltage sensor device 14 is covered by a coating material, it may affect the performance and measurement abilities of the automated voltage measurement system 12. In certain embodiments, the voltage sensor device 14 may include a removable cover or shield, which may automatically retract or uncover a probe upon engagement with the applicator 18 and/or control signals from the computer 16.

In the embodiment, system control computer 16 may automatically sequence a measurement, via a software program, for each of the plurality of applicators 18 of electrostatic spray coating system 10. Moreover, as a voltage for each of the applicators 18 is measured, the measurements may be communicated to the system control computer 16 via appropriate connections 17, such as network or electrical cables. The system control computer 16 may use a sequencing software as well as measurement and control hardware to coordinate the movement of robotic arms 20 with the voltage sensor device 14. Further, system control computer 16 may log the measurements to a database and/or compare the values to a table, trends, alarm limits, or other data.

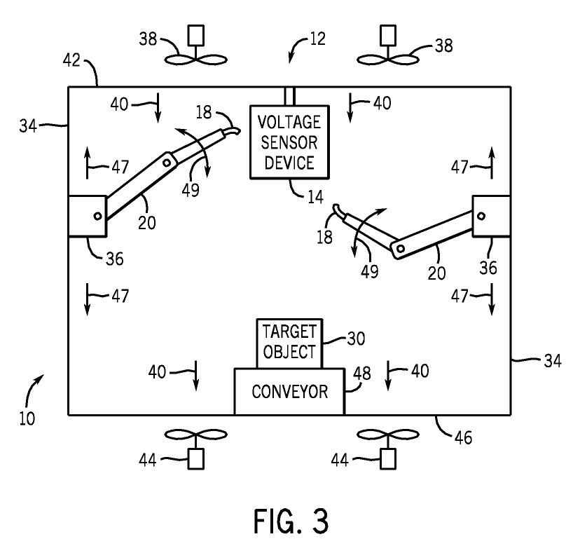

FIG. 3 is a side view of a block diagram of an embodiment of electrostatic spray coating system 10. Specifically, the embodiment shown in FIG. 3 is a side view of the diagram illustrated in FIG. 2. As depicted, fans 38 are located in the upper portion of a spray coating system 10 enclosure and may direct air downward, as shown by arrows 40, toward the floor of the enclosure of electrostatic spray coating system 10. In the embodiment, air vents may be located in ceiling 42 to allow air to pass through ceiling 42 downward in direction 40, thereby drawing airborne coating particles toward the lower portion of the enclosure. Further, fans 44 may be located beneath floor 46 which may also include air vents, thereby drawing air downward in direction 40. In addition, voltage sensor device 14 is shown mounted to ceiling 42 in a central location, thereby enabling robotic arms 20 and applicators 18 on each side of the enclosure to access the voltage sensor device 14. Further, the flow of air in direction 40 draws airborne coating material downward and away from the voltage sensor device 14, thereby substantially protecting it from exposure to the coating materials.

As previously discussed, system control computer 16 may control the position of robotic arms 20, robotic arm base 36, and applicator 18 to enable a test sequence that automates the measurement of the high voltage applicators 18 located in electrostatic spray coating system 10. As depicted, a target object, such as an automotive component, may be located near the floor 46 of the enclosure and may be moved by a suitable material handling device, such as conveyor 48. As depicted, robotic arms 20, applicators 18, and robotic bases 36 may move vertically in direction 47 as well as horizontally along wall 34 in order to sequence and maneuver through an automated voltage measurement procedure. Further, robotic arms 20 enable rotational and linear (e.g., translational) movement in many directions, including direction 49, to position the electrostatic applicator 18 to enable measurement by voltage sensor device 14, in addition to movement during a coating process or operation. For example, each robotic arm 20 may enable rotation about multiple (e.g., 1, 2, or 3) axes at each joint (e.g., 1, 2, 3, or more). The arrangement of automated voltage measurement system 12 enables software and hardware included in the system to manipulate components of electrostatic spray coating system 10, thereby providing a simple implementation for a high voltage measurement that ensures optimal performance of the electrostatic spray coating system 10 and minimizes downtime for the system.

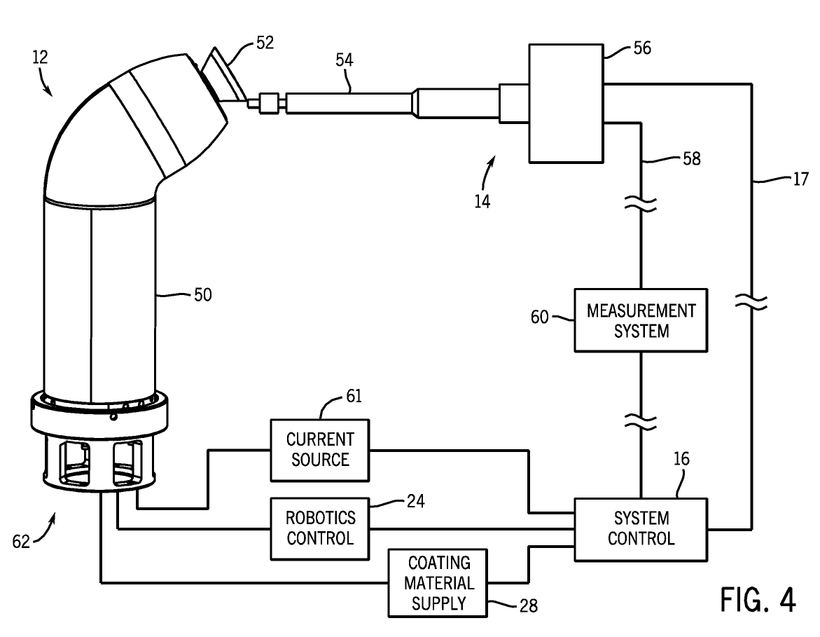

FIG. 4 is a schematic diagram of an embodiment of automated voltage measurement system 12, including voltage sensor device 14 and rotary atomizer 50, which may be used with the robotic arms 20 and arrangements of FIGS. 1-3. Rotary atomizer 50 is an embodiment of an applicator that may be coupled to the end of a robotic arm coating system. Rotary atomizer 50 is an electrostatic coating applicator that includes bell cup 52, which is a high voltage component of the electrostatic applicator. The bell cup 52 may source a voltage of up to or greater than 10, 20, 30, 40, 50, 60, 70, 80, 90, 100, 110, 120, 130, 140, or 150 kilovolts (kV) that may be measured via voltage sensor device 14 using a contact or a non-contact voltage sensor.

As depicted, a voltage sensing contact probe 54 is a component of voltage sensor device 14 that enables a voltage measurement of the electrostatic spray components of rotary atomizer 50. Voltage sensor device 14 includes contact sensor circuitry 56 which may contain voltage sensor hardware, such as filters, amplifiers, analog-to-digital (A/D) converters, and other components to condition, modulate, and/or convert the voltage reading to a signal that may be communicated via electrical or network leads 58 to measurement system 60. In the embodiment, measurement system 60 may receive the voltage measurement via leads 58 and perform additional analysis on the voltage measurement. Specifically, measurement system 60 may include A/D converters, filters, and/or software for analysis of measurement signals received via leads 58. As previously discussed, voltage sensor device 14 may be located centrally, mounted on a ceiling of the spray booth, or a plurality of sensor devices 14 may be located in several positions within the spray booth enclosure.

As depicted, voltage sensor device 14 may be connected to measurement system 60, thereby communicating voltage measurements to system control 16 in order to enable control and perform an automated voltage measurement process. System control computer 16 may control and be coupled to several components, including current source 61, robotics control 24, and coating material supply system 28. In an embodiment, current source 61 may drive current through electrostatic spray coating system 10 components including robotic arms 20 to the rotary atomizer 50 applicator. The rotary atomizer applicator may include electrical components and hardware, such as a voltage cascade, which increases a voltage input to a desired high voltage level suitable to be utilized by and connected to electrostatic spray components, such as bell cup 52. For instance, the input voltage may be increased by the voltage cascade to a high voltage level, such as 50-150 kV, 75-125 kV, or 90-100 kV. Current source 61, robotics control system 24 and coating material supply system 28 may be routed through electrostatic spray coating system components, including robotic arm 20, to connection 62 located on rotary atomizer applicator 50. In an embodiment, system control computer 16 may execute software code including an automated test sequence or routine to manipulate (e.g., via robotic arms 20) the location of a plurality of rotary atomizer applicators 50 in order to perform a high voltage measurement of bell cup 52 via contact sensor 54 of voltage sensor device 14. Further, automated voltage measurement system 12 may enable sequencing of tests of a plurality of electrostatic applicators 50, thereby enabling multiple electrostatic spray applicators to be tested by a single voltage sensor device 14.

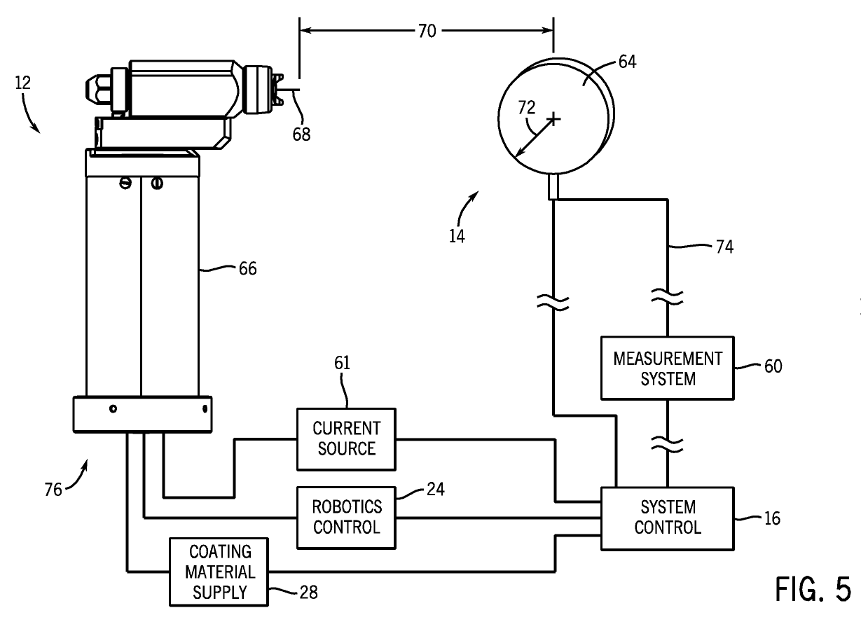

FIG. 5 is a schematic diagram of an embodiment of automated voltage measurement system 12 including voltage sensor device 14, measurement system circuitry 60, current source 61, and system control computer 16. Again, the voltage sensor device 14 may be used with the robotic arms 20 and configurations of FIGS. 1-3. In the illustrated embodiment, voltage sensor device 14 includes non-contact sensor 64, which may be composed of a suitable electric field voltage measurement device, such as an induction volt meter, to measure the voltage of the electrostatic applicator. As depicted, spray gun applicator 66 is an electrostatic spray coating applicator that is measured using non-contact sensor 64, which may be referred to as a test plate. Spray gun applicator 66 includes a high voltage electrode 68 that enables electrostatic application of a coating material to a target object. For instance, high voltage electrode 68 may be supplied with a voltage of 50-150 kV, 75-125 kV, or 90-100 kV in order to electrostatically spray a target object. As depicted, high voltage electrodes 68 may be located at a fixed distance 70 from non-contact sensor 64 during an automated voltage measurement. Specifically, in order to perform an automated voltage measurement with non-contact sensor 64, the sensor may be positioned at a known constant distance 70 from high voltage electrode 68. Further, a relationship of distance 70 to radius 72 may enable the automated voltage measurement system 12 to precisely measure the voltage of high voltage electrodes 68. For example, a relationship wherein the radius 72 is about equal to or greater than the distance 70 may provide an optimal measurement arrangement. For example, in an embodiment with certain measurement hardware, distance 70 may be equal to radius 72 to accurately measure the voltage of the electrostatic spray gun applicator 66. Non-contact sensor 64 may be coupled to measurement system 60 by electrical leads 74.

In addition, non-contact sensor 64 may be coupled to system control computer 16. System control computer 16 may control an automated voltage measurement using a software routine installed on the computer. In an embodiment, measurement system 60 may include components that allow the high voltage measurement to be translated, recorded, and analyzed by system control computer 16 and associated databases and/or software. In addition, measurement system circuitry 60 may include components such as analog to digital converters, amplifiers, filters, and other components. For example, measurement system circuitry 60 may include a connection to ground that has a resistance of less than 500 kilo-ohms. This circuitry may enable an accurate measurement to be recorded by non-contact sensor 64 and automated voltage measurement system 12. System control computer 16 may also be coupled to current source 61, robotic control system 24 and coating material supply 28. Spray gun applicator 66 may be coupled via connection 76 to current source 61, robotic control system 24 and coating material supply 28. Current source 61 provides power that may be amplified to provide the high voltage signal to the electrode 68. In the embodiment, automated voltage measurement system 12 enables a sequence to measure the high voltage components of the electrostatic spray coating system 10, thereby enabling simple, fast, and safe techniques to measure the high voltage. In addition, the measurement system 12 may also measure the high voltage of an electrostatic applicator without requiring multiple operators or significant downtime of a spray booth. Automated voltage measurement system 12 also enables calibration of electrostatic spray coating system 10 components, thereby ensuring a quality spray coating application by the system, reducing costs, and reducing the incidence of re-application of a spray coating.

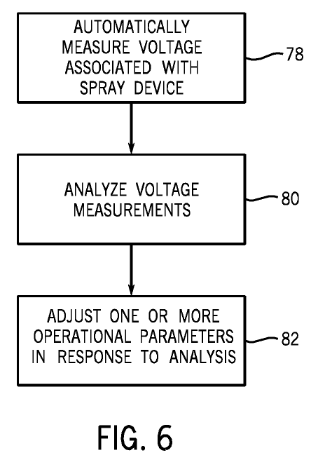

FIG. 6 is a flow chart of an automated process to measure the voltage of an electrostatic spray coating system 10 and to analyze the results of the voltage measurements in accordance with the embodiments of FIGS. 1-5. The illustrated method may include steps performed by hardware and software within electrostatic spray coating system 10 in order to perform an automated voltage measurement and to enable analysis and/or diagnostics of the system if an error or fault is found within the electrostatic spray coating system 10. For example, the process may obtain measurements with or without contact (see FIGS. 4 and 5) without user entry into a booth by using robotic arms 20. In step 78, the system performs an automated voltage measurement on a spray system 10. Next, step 80 performs an analysis of the voltage measurements taken. This analysis may include alarms, trends, look-up tables, and other analysis that will be discussed in detail later. Further, in step 82, the electrostatic spray coating system 10 may adjust one or more operational parameters in response to the system analysis in performed in step 80. For example, if the voltage is too low, then the system 10 may increase the voltage. If the voltage is too high, then the system 10 may decrease the voltage. The system may also adjust the distance between the target object and applicator, the fluid flow rate, and other parameters.

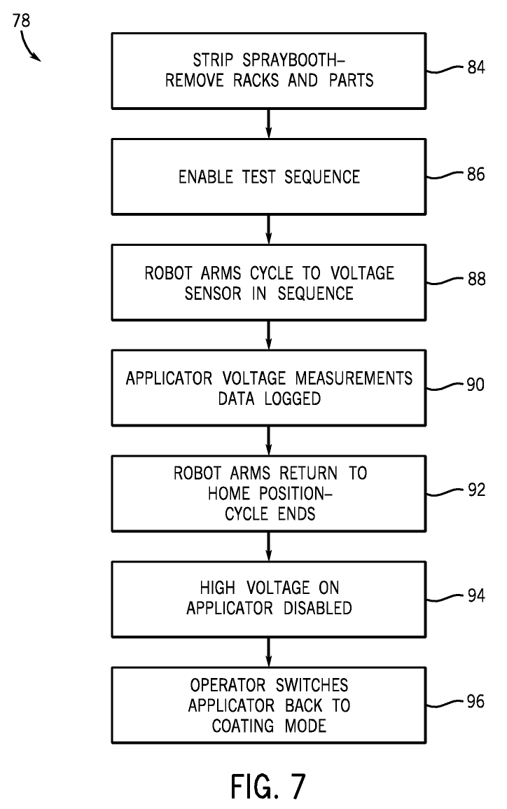

FIG. 7 is a flow chart depicting an embodiment of step 78 shown in FIG. 6. In the steps included within step 78, the system may perform an automatic voltage measurement for a spray system or spray device. In step 84, the components, racks for target objects, and/or target objects may be removed or stripped from a spray booth, either manually by an operator or by an automated system. Step 84 prepares the electrostatic spray coating system 10 spray booth or enclosure for the automated voltage measurement. In step 86, a test sequence is enabled by the automated voltage measurement system 12. For example, software installed on system control computer 16 may initiate the test sequence, thereby beginning the automated test by placing the hardware, applicators, and software in the proper state for testing. In step 88, the system controls and commands the applicators coupled to the robotic arms to cycle through a sequence in which they are each measured by voltage sensor device 14. A plurality of robotic arms 20, each with an electrostatic spray applicator attached to the end, may position each of the applicators for a sequential voltage measurement in step 88. In step 90, the applicator voltage measurements may be data logged to a database and/or a computer, such as system control computer 16. These data logged measurements may be utilized for historical data analysis, trending, and other data analysis. In step 92, the robotic arms 20 may return to a home position, at the end of the test cycle, to prepare the system for application of coating materials. The home position for the robotic arms 20 may be in the position in which the robotic arms begin to electrostatically apply a spray coating to a target object after the automated voltage measurement sequence or process has ended. In step 94, the electrostatic applicator high voltage is disabled for testing purposes. In step 96, an operator may switch the system back to coating mode or resting mode depending upon the next procedure to be performed within the electrostatic spray coating system 10. In certain embodiments, the process 78 may be a computer implemented method including code or instructions to perform each step.

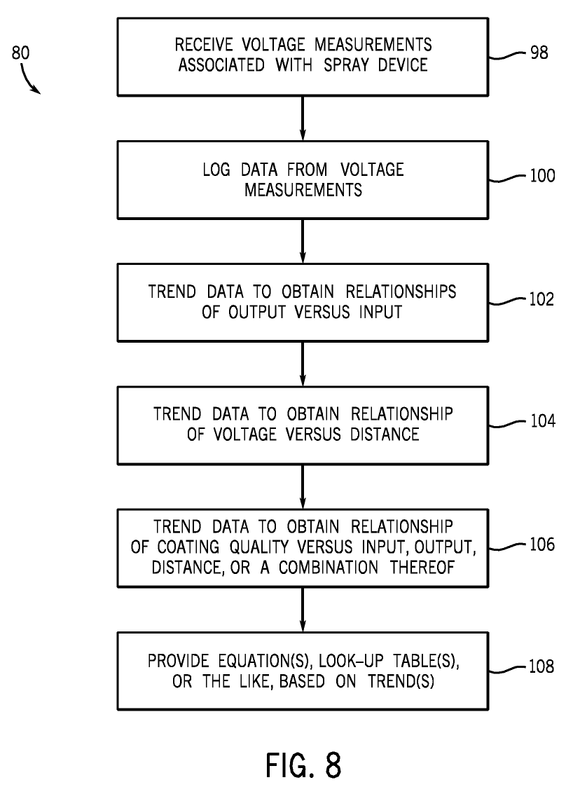

FIG. 8 is a detailed flow chart describing the steps contained within the voltage measurement analysis step 80. In step 98, voltage measurements for each spray device are received by the system. Specifically, the signals are sent to the system control computer 16. In step 100, the data is logged from each of the voltage measurements. In step 102, the logged data may be trended to obtain a relationship of voltage output versus a voltage input to the electrostatic applicator. For example, the voltage input to a cascade inside the electrostatic applicator may be compared to the high voltage value detected by voltage sensor device 14. In step 104, the data may be trended to obtain a relationship of voltage versus distance (e.g., distance between applicator and probe). This step may be utilized in a system where the non-contact sensor 64 is utilized to measure a voltage of the electrostatic applicator. Specifically, each of the voltage measurements taken by the non-contact sensor 64 may be at a known distance in order to accurately measure the voltage of the electrostatic applicator. As this data is logged, it may be analyzed to produce an equation, function, trend, or other technique to obtain a relationship between the distance from the non-contact sensor 64 to the electrostatic applicator 18. In step 106, the data may also be trended over time to obtain a relationship of coating quality versus voltage input, voltage output, distance, and/or a combination thereof. For instance, an electrostatic applicator 18 voltage may be measured and logged by the automated voltage measurement system 12 and correlated to a measured coating quality, to obtain a relationship between a trend of voltage measurements and the coating quality of the electrostatic spray coating system 10 being analyzed. As appreciated, the distance 70 may be utilized for the measurement in a non-contact sensor 64 based voltage measurement system. In step 108, equations may be provided along with lookup tables and other relationships based on data trends and other parameters within the system. Again, the process 80 may be a computer implemented method including code or instructions to perform each step.

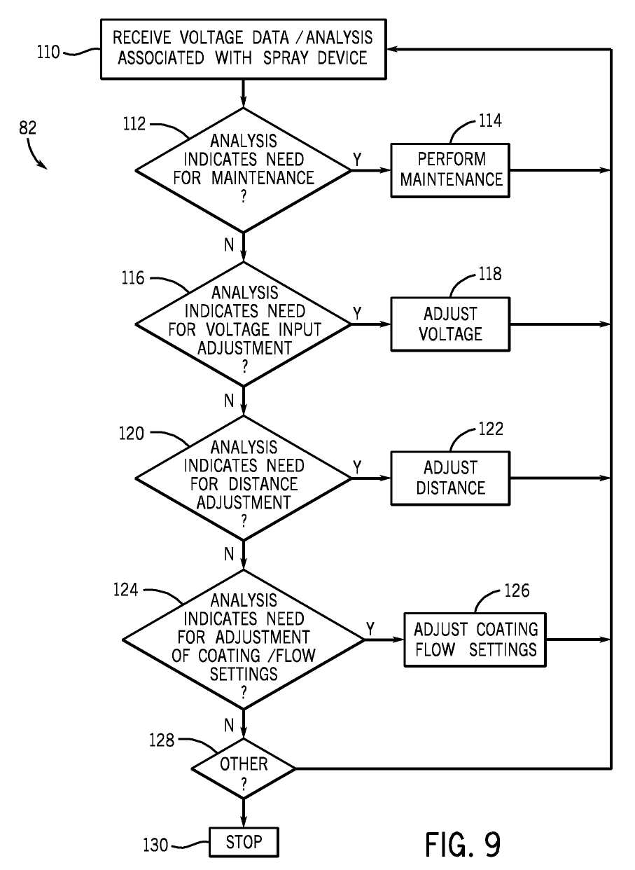

FIG. 9 illustrates an embodiment of a flow chart for electrostatic spray coating system 10, including detailed steps that may occur when adjusting operational parameters in response to analyzed voltage measurements. In step 110, the voltage data and/or analysis of the data are received for the spray device being monitored. In step 112, the process may indicate a need for system maintenance, such as replacement of an electronic component or other equipment maintenance. If analysis indicates a need for maintenance, then maintenance may be performed, as shown by step 114. If maintenance is not needed, step 116 is performed to determine if a voltage input for the spray device should be adjusted. A voltage adjustment step for the input voltage may be performed in step 118. For example, if a voltage input to an electrostatic applicator 18 causes a low reading and needs to be increased, then the electrostatic applicator 18 may be adjusted to increase the high voltage output to applicator 18 to operate efficiently. In step 120, the system determines if a distance adjustment is needed for a non-contact sensor based system. The adjustment of the distance between the electrostatic applicator 18 and the target object may be performed in step 122. Specifically, the distance 70 between a target object being coated by the electrostatic spray coating system 10 may be reduced or increased based on the detected voltage of the electrostatic applicator 18. If a distance adjustment is not needed, then step 124 determines if an adjustment of the flow rate of coating material is desirable. The adjustment to the coating flow settings may be performed within step 126. For instance, a flow rate can be decreased in response to the higher voltage output of the electrostatic applicator 18 to enhance the coating quality of the system. If no adjustment of coating or flow settings is desirable, then step 128 may perform additional analysis and/or corrective tasks to improve the performance of electrostatic spray coating system 10. In step 130, the system testing and measurement analysis is stopped. In certain embodiments, the process 82 may be a computer implemented method including code or instructions to perform each step.

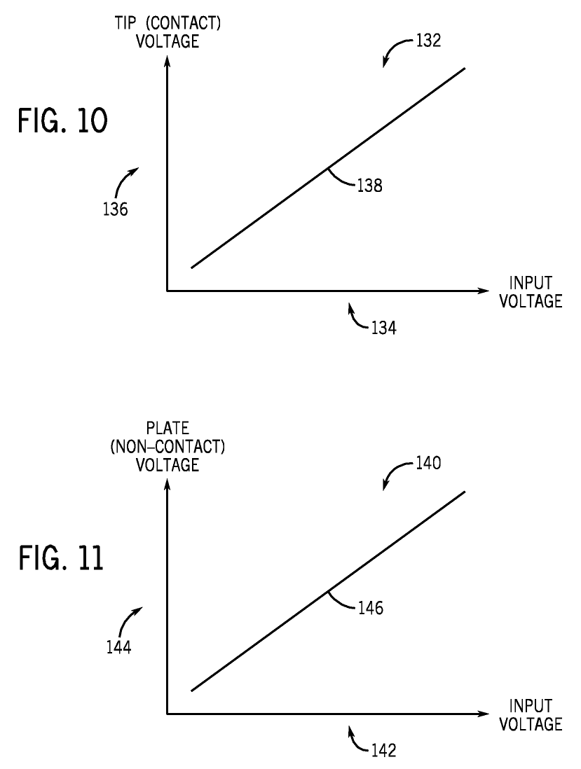

FIG. 10 is a chart 132 of a relationship between the electrostatic applicator 18 input voltage, shown on X-axis 134, versus the measured electrostatic applicator 18 tip voltage, shown on the Y-axis 136. Further, the chart 132 illustrates the measured voltage, as measured by a contact voltage sensor. As depicted, the voltage of the electrostatic applicator 18 tip, as compared to the input voltage, may be linear relationship, shown by line 138. This relationship, or another trending or function, may be used to analyze and/or troubleshoot an electrostatic spray coating system based on the automated voltage measurements. For instance, a series of high voltage measurements may be compared to a predicted reading, according to the curve function shown in the chart.

FIG. 11 is a chart 140 illustrating the applicator 18 input voltage 142, shown on the X-axis, versus the non-contact sensor voltage measurement 144, shown on the Y-axis. As depicted by data plot 146, the relationship is linear, illustrating that the input voltage may be proportional to the sensed voltage of the non-contact based voltage measurement system. In another embodiment, the relationship may be similar or different than shown by chart 140. This trend or function may be used to analyze and/or troubleshoot an electrostatic spray coating system based on the automated voltage measurements.

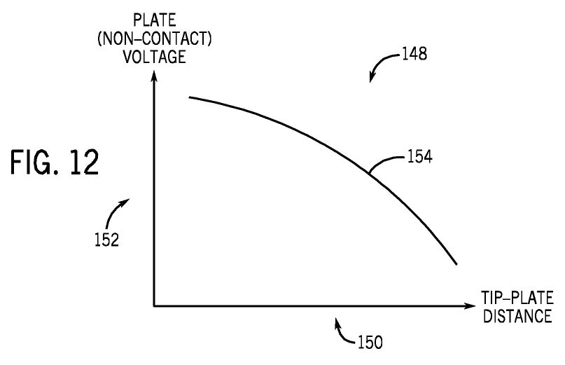

FIG. 12 is a chart 148 illustrating a plot of the distance from applicator 18 tip to a non-contact sensor plate, shown on X-axis 150, versus the measured voltage of the non-contact sensor plate, shown on Y-axis 152. In the embodiment, the relationship of the plate voltage may be described as a curve, shown as plot 154. As appreciated, the distance between the applicator 18 tip and the non-contact sensor plate may reduce the voltage as the distance is increased between the two components.

In the embodiments discussed above with reference to FIGS. 1-12, the systems and method automated voltage measurements and control (e.g., adjustments based on measurements_ to reduce or eliminate user entry into spray areas (e.g., a booth), reduce or eliminate downline of equipment, and improve accuracy and performance of the spray equipment. The voltage measurements may be achieved with contact and/or without contact between a probe and spray applicator. In certain embodiments, contact and non-contact measurements may be taken for comparison and to improve accuracy. The measurements may be achieved with robotic arms 20 or other equipment. Thus, a user does not need to manually hold a probe against an applicator.

While only certain features of the invention have been illustrated and described herein, many modifications and changes will occur to those skilled in the art. It is, therefore, to be understood that the appended claims are intended to cover all such modifications and changes as fall within the true spirit of the invention.

1. A system, comprising:
a high voltage coating applicator;
a voltage sensor; and
a coating system controller configured to automate a voltage measurement of the high voltage coating applicator by the voltage sensor.

2. The system of claim 1, wherein the voltage sensor comprises a contact voltage sensor configured to measure a voltage by contacting the high voltage coating applicator.

3. The system of claim 1, wherein the voltage sensor comprises a non-contact sensor configured to measure a voltage without contacting the high voltage coating applicator.

4. The system of claim 1, wherein the high voltage coating applicator comprises an electrostatic spray device.

5. The system of claim 4, wherein the electrostatic spray device comprises a bell cup.

6. The system of claim 4, wherein the electrostatic spray device comprises a high voltage electrode.

7. The system of claim 1, wherein the voltage sensor is mounted in a central location along a series of robotic arms, and each robotic arm comprises one of the high voltage coating applicators.

8. The system of claim 1, comprising a booth having the high voltage coating applicator and the voltage sensor, wherein the coating system controller is configured to obtain the voltage measurement and adjust voltage, distance, fluid flow, or a combination thereof, of the high voltage coating applicator without user entry into the booth.

9. A system, comprising:
a non-contact sensor; and
a controller coupled to the non-contact sensor, wherein the controller is configured to obtain a measurement indicative of voltage at a distance between an electrostatic spray device and the non-contact sensor, and the controller is configured to adjust voltage, fluid flow, distance, or a combination thereof, of the electrostatic spray device in response to the measurement.

10. The system of claim 9, wherein the non-contact sensor comprises a test plate disposed at a known distance from the electrostatic spray device.

11. The system of claim 10, wherein the test plate has a disc shape with a radius, and the distance is at least equal to or greater than the radius.

12. The system of claim 9, wherein the non-contact sensor has a non-linear relationship between voltage and distance from the electrostatic spray device.

13. The system of claim 9, comprising a ceiling mount coupled to the non-contact sensor.

14. The system of claim 9, comprising a wall mount coupled to the non-contact sensor.

15. The system of claim 9, comprising a plurality of robotic arms, wherein the non-contact sensor is accessible by the plurality of robotic arms.

16. A system, comprising:
a contact sensor;
a positioning device; and
a controller coupled to the contact sensor and the positioning device, wherein the controller is configured to obtain a contact measurement of voltage directly between the contact sensor and an electrostatic spray device via positional manipulation by the positioning device, and the controller is configured to adjust voltage, fluid flow, distance, or a combination thereof, of the electrostatic spray device in response to the contact measurement.

17. The system of claim 16, wherein the contact sensor comprises a voltmeter.

18. The system of claim 16, comprising a ceiling mount coupled to the contact sensor.

19. The system of claim 16, comprising a wall mount coupled to the contact sensor.

20. The system of claim 16, wherein the positioning device comprises a robotic arm, wherein the robotic arm comprises the electrostatic spray device.

21. (canceled)
